(19) United States
(12) Patent Application Publication
(10) Pub. No.: US 2009/0166421 A1
(43) Pub. Date: Jul. 2, 2009

(54) RFID READER / CARD COMBINATION TO CONVERT A CONTACT SMARTCARD READER TO CONTACTLESS

(75) Inventor: David Finn, Tourmakeady (IE)

Correspondence Address: GERALD E. LINDEN;C/O STAUFFER, 1006 MONTFORD RD., CLEVELAND HEIGHTS, OH, 44121, US

(73) Assignee: DPD Patent Trust Ltd, Tourmakeady (IE)

(21) Appl. No.: 12/399,952

(22) Filed: Mar. 8, 2009

Related U.S. Application Data
(63) Continuation-in-part of application No. 11/779,299, filed on Jul. 18, 2007.
Application No. 11/779,299 is a continuation-in-part of application No. 11/420,747, filed on May 27, 2006.
Application No. 11/420,747 is a continuation-in-part of application No. 11/355,264, filed on Feb. 15, 2006.
(60) Provisional application No. 61/035,053, filed on Mar. 10, 2008.
(60) Provisional application No. 61/073,753, filed on Jun. 18, 2008.

(51) Int. Cl. G06K 7/01

(52) U.S. Cl. 235/439

(57) ABSTRACT

An interface conversion reader (ICR) to convert a contact smartcard reader to a contactless smartcard reader. The ICR may have a rectangular card body format for insertion into a slot provided in a conventional contact smartcard reader, with a portion of said card body protruding out of the reader after insertion; wherein the protruding portion of said card body incorporates a contactless interface with an antenna to inductively couple and communicate with a contactless smartcard. The ICR may comprise an ISO 7816 contact interface to communicate with the contact smartcard reader and to draw power from said reader to activate the conversion of ISO 7816 data to ISO 14443 data.

### TECHNICAL FIELD

The invention relates to contact smartcard readers, and also to contactless cards.

### BACKGROUND

### Patents and Publications

U.S. Pat. No. 6,398,116 (Angewandte Digital, Kreft) describes a chip card with at least two coil devices (2, 3) for transferring data and/or energy with a write/read device (terminal) without contacts and optionally, with contacts (1). One or several of the coils (2) of the first coil device (2) is/are a coil/s for the close coupled environment, and one or several of the coils (3) of the second coil device (3) is/are a coil/coils for the remote coupled environment. An electronics unit is able to differentiate between the coil devices (2, 3) according to different physical features e.g., phase and/or frequency and/or amplitude and/or energy differences. When the remote coupled environment (3) and close coupled environment coil(s) (2) are situated in an electromagnetic alternating field at the same time and enough energy is being supplied through the remote coupled environment coil(s), a stereo signal (S1) which takes on a characteristic value (A1) is generated in a first part (4) of said electronics unit (6). The differences in the electromagnetic alternating field between the remote coupled environment (3) and close coupled environment coil(s) (2) are used in the form of phase and/or frequency and/or amplitude and/or energy differences to produce a second characteristic value (A2) of the stereo signal (S1). When the differences in the electromagnetic alternating field between the remote coupled environment (3) and close coupled environment coil(s) (2) disappear, the stereo signal (S1) is either not produced or takes on a third value (A3). In both cases the chip card can still be used with its environment with restricted functions, for as long as the energy supplied from the remote coupled environment coils (3) permits. When the stereo signal (S1) with the second value (A2) is produced the chip card can be used with additional functions, using the stereo effect to fulfil different functions according to whether it is operating with the close coupled environment or the remote-coupled environment.

U.S. Pat. No. 6,839,772 (Inside Technologies) describes a chip card reader having contact and contactless operating modes whereby the chip card reader (10) comprising a central processing unit (20) comprising means (MP2, MEM2, PG20, 23) for emitting and receiving, on a communication bus (60), binary messages with a first format determined by a communication protocol for contact chip card, a card receiving device (40) comprising a contact card connector (42) connected to the central processing unit (20) by means of the communication bus (60), and a read head (30) for contactless chip card (53) comprising a serial interface (31). According to the invention, the serial interface (31) of the contactless read head (30) is directly connected at least to a data wire (I/O) of the communication bus, and the contactless read head (30) is arranged in a hardware and/or software way so that it does not respond to a contact chip card activation command and responds to a specific activation command (ACTIV) different from a contact chip card activation command.

U.S. Pat. No. 7,248,834 (Sony) describes a communication apparatus whereby a portable terminal includes a near-field communication (NFC) device for performing information communication via near-field communication; a write button; and a read button. In order to write information stored in the portable terminal into an information providing apparatus, a user moves the portable terminal close to the information providing apparatus such that a distance between the portable terminal and the information providing apparatus is 10 cm or less while pressing the write button. In order to read information stored in the information providing apparatus into the portable terminal, a user moves the portable terminal close to the information providing apparatus such that a distance between the portable terminal and the information providing apparatus is 10 cm or less while pressing the read button.

US 20030141365 (SCM Microsystems) describes a chip card reader comprising of a housing according to a PCMCIA format. The housing includes a base plate (12) and a cover plate (14) extending between a plug-in socket (32) and an insertion slot for a chip card (38). The base plate (12) and the cover plate (14) are each made of a plastic part (20) and a metallic part and are assembled by interconnecting the metallic parts of both plates (12, 14).

US 20030169152 (Inside Contactless) describes a contactless integrated circuit reader operating by inductive coupling, comprising an antenna circuit for sending an alternating magnetic field, circuits for applying an alternating excitation signal to the antenna circuit and circuits for modulating the amplitude of an antenna signal present in the antenna circuit according to data to be sent. The reader includes circuits for simulating the operation of a contactless integrated circuit, arranged to inhibit the application of the excitation signal to the antenna circuit and to apply a load modulation signal to the antenna circuit when data is to be sent. The load modulation signal is capable of disturbing a magnetic field sent by another contactless integrated circuit reader and of being detected by the other contactless integrated circuit reader.

US 20040073726 (Aladdin Knowledge Systems) describes a smartcard-host system that operates without the intermediation of a smartcard reader. The smartcard-host system comprises a host, which has a USB interface, and a portable device, which provides smartcard function(s). The portable device has a smartcard chip for performing the smartcard function(s); a USB interface for connecting the portable device with the host via USB protocol; and a microprocessor for controlling the transfer of data between the USB interface and the smartcard chip, for converting data from a USB format to the format of the smartcard chip and for converting data from the format of the smartcard chip to a USB format.

US 20060148404 (Nokia) describes the docking of short-range wireless communication tags, such as Radio Frequency Identification (RFID) or Near Field Communication (NFC) smartcards onto a mobile terminal having a corresponding short-range wireless communication reader device, such as an RFID reader or a NFC reader. Docking of the tag to the mobile terminal may take the form of attaching or otherwise affixing the tag to the mobile terminal via a tag holding mechanism, such that the reader device may periodically read the tag and also provide for interrogation and reading of other external short-range wireless communication tags and devices in the proximity of the mobile terminal when the reader device is not communicating with the docked tag

US 20070055633 describes a secure NFC apparatus includes a plug-in socket, an NFC unit, and a protocol matching unit. A security module is inserted in the plug-in socket. The NFC unit communicates with the outside via non-contact NFC using signals based on an S2C protocol. The protocol matching unit determines the type of chip in the inserted security module, generates a chip identification signal according to results of the identification, and matches the protocol of the signals based on the S2C protocol, which are input to and output from the NFC unit, with the protocol of the signals, which are input to and output from the security module, according to the chip identification signal.

DE 100,60,866 C1 (AmaTech, Finn) describes a computer peripheral system such as an optical mouse having an integrated RFID reader and an opening to accept the insertion of a contactless card to communicate with said reader.

US 20070250707 (Sony) describes a method and device for accessing data using near field communication. The NFC interface of the electronic device is positioned within communication range of a second NFC interface of a second device, whereby data is transferred to the first electronic device from the second electronic device. The data is sorted into a layered data structure including at least two layers, wherein a first layer includes directly presentable first information, such as brief content description, and a second layer includes a communication address to an information source accessible by means of a network connection to download further information.

US 20070263596 (Inside Contactless) describes a method for routing incoming and outgoing data in an NFC chipset comprising at least two host processors and one RFID-type contactless data send/receive interface configurable according to several operating modes and according to several contactless communication protocols includes routing, to at least one of the host processors, data received by the contactless data send/receive interface via a contactless data transmission channel. The method further includes determining a destination point of the data in a host processor using as criteria to determine the destination point the operating mode and the contactless communication protocol used by the contactless data send/receive interface to create the contactless data transmission channel through which the data are received.

US 20080032626 describes a portable electronic apparatus with NFC application and the method of operating the portable electronic apparatus. The portable electronic apparatus includes an application module, an active NFC device, a passive NFC device, and a power supply unit. The application module is utilized for performing a main function of the portable electronic apparatus. The active NFC device which is coupled to the application module is utilized for communicating with an NFC device outside the portable electronic apparatus. The passive NFC device is utilized for communicating with an NFC device outside the portable electronic apparatus. The power supply unit which is coupled to the application module and the active NFC device is utilized for powering the application module and the active NFC device.

### RELATED, COPENDING, PATENT APPLICATIONS

Ser. No. 11/779,299 filed by Finn on 18 Jul. 2007 (“C18”) describes a portable RFID reader apparatus having a contactless interface and slots or recesses for insertion of contactless smartcard fobs, including ID card, and having a wireless interface for communicating with a token plugged into a computer, provides physical and logical access.

U.S. Ser. No. 11/420,747 filed by Finn on 27 May 2006 (“C16”) describes a pocket-size RFID reader apparatus having a contactless interface and a slot for insertion of a contactless smartcard fob, and having a biometric sensor, thereby providing two levels of personalization. The apparatus may have a wireless interface; and a slot for insertion of a wireless SD I/O device. The apparatus may have a slot for insertion of an external memory device. The apparatus may have a mechanical connection (contact) interface. The apparatus may also have an RF interface for reading an electronic immobilizer within the apparatus.

As set forth in C16, the RFID reader has a contactless interface selected from the group consisting of ISO 14443, ISO 15693, NFC, and any similar interface. And it has an interface for communicating with an Internet-capable appliance; and the interface with the Internet-capable appliance in a Private Area Network is selected from the group consisting of Zigbee, NFC, Bluetooth, UWB, wireless USB, Infrared; and the interface with the Internet-capable appliance for a Local Area Network is selected from the group consisting of 802.11 a/b/g, 802.11n and WIMAX.

In addition, the RFID reader has a biometric membrane sensor with actuator for powering up the apparatus and authenticating the user. The apparatus can generate “One-Time-Passwords” and can synchronize itself with an Internet atomic clock.

An important feature of C16 is the functional combination of the contactless card or fob with the reader, in applications (uses), meaning that the user carries the contactless card or fob in the RFID reader with multiple interfaces when performing a transaction or an exchange.

### GLOSSARY, DEFINITIONS, ABBREVIATIONS

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks (®).
Contact As used herein, “contact interfaces” (or “mechanical interface”) refers to mechanical (wired) connections between one device and another, such as via a cable or inserting a module into a socket. The following are examples of contact interfaces and/or devices that typically connect via a contact interface.
ISO 7816 ISO7816 defines specification of smartcard contact interface IC chip and IC card. The main ISO standard relating to smartcards is ISO7816: “Identification cards: integrated circuit cards with contacts”.
USB CCID USB is short for Universal Serial Bus. CCID is short for Chip/Smartcard Interface Devices. ICCD is short for Integrated Circuit(s) Card Devices. CCID is intended to use one generic device driver for different types of Smartcard readers without the need of each vendor having to supply its own software driver.
Contactless As used herein, “contactless interfaces” refers to high radio frequency (RF) connections between one device and another, typically over a very short distance, such as only up to 100 cm. The following are examples of contactless interfaces and/or devices that typically connect via a contactless interface.
ISO 14443 ISO 14443 RFID cards; contactless proximity cards operating at 13.56 MHz with a read/write range of up to 10 cm. ISO 14443 defines the contactless interface smartcard technical specification.
ISO 15693 ISO standard for contactless integrated circuits, such as used in RF-ID tags. ISO 15693 RFID cards; contactless vicinity cards operating at 13.56 MHz with a read/write range of up to 100 cm. (ISO 15693 is typically not used for financial transactions because of its relatively long range as compared with ISO 14443.)
NFC Near Field Communication (NFC) technology is currently developed by an industrial consortium grouped under the name Forum NFC (http://www.nfc-forum.org). The NFC technology is derived from RFID technology and uses NFC readers having several operating modes, i.e., a “reader” mode, a “card emulation” mode, and a “device” mode (also referred to as “device-to-device” mode). In the “reader” mode, the NFC reader operates like a conventional RFID reader to read- or write-access an RFID chip (chip card or contactless tag). The NFC reader emits a magnetic field, sends data by modulating the amplitude of the magnetic field, and receives data by load modulation and inductive coupling. In the “emulation” mode, described by the patent EP 1 327 222 in the name of the applicant, the NFC reader operates passively like a transponder to communicate with another reader and to be seen by the other reader as an RFID chip. The reader does not emit any magnetic field, receives data by demodulating a magnetic field emitted by the other reader, and sends data by modulating the impedance of its antenna circuit (load modulation). In the “device” mode, the reader must match with another reader in the same operating mode, and each reader alternately enters a passive state (without field emission) for receiving data and an active state (with field emission) for sending data.

In addition to these three operating modes (other operating modes could be designed in the future), an NFC reader can implement several contactless communication protocols and is for example capable of exchanging data according to the ISO 14443-A protocol, the ISO 14443-B protocol, the ISO 15693 protocol, or the like. Each protocol defines a frequency of emission of the magnetic field, a modulation method for modulating the amplitude of the magnetic field to send data in active mode, and a load modulation method by inductive coupling to send data in passive mode. Therefore, an NFC reader is a multimode and multi-protocol device.
Prox Card Proximity card is a generic name for contactless integrated circuit devices used for security access or payment systems. It can refer to the older 125 KHz devices or the newer 13.56 MHz contactless RFID cards, most commonly known as contactless smartcards. Modern proximity cards are covered by the ISO 14443 (Proximity Card) standard. There is also a related ISO 15693 (Vicinity Card) standard. Proximity cards use an LC circuit. An IC, capacitor, and coil are connected in series. The card reader presents a field that excites the coil and charges the capacitor, which in turn energizes the IC. IC then transmits the card number via the coil to the card reader. The card readers communicate in Wiegand protocol that consists of a data 0 and a data 1 circuit. The earliest cards were 26 bit. As demand has increased bit size has increased to continue to provide unique numbers. Often, the first several bits can be made identical. These are called facility or site code. The idea is that company “Alice” has a facility code of xn and a card set of 0001 through 1000 and company “Bob” has a facility code of yn and a card set also of 0001 through 1000.
RFID Short for “Radio Frequency Identification”. An RFID device interacts, typically at a limited distance, with a “reader”, and may be either “passive” (powered by the reader) or “active” (having its own power source, such as a battery).

### ABBREVIATIONS

### ICC Integrated Circuit Card

### ICR Interface Conversion Reader

CLK External applied clock signal of the terminal
CLK′ Internal generated clock signal

### PICC Proximity Integrated Circuit Card

### PCD Proximity Coupling Device

### SUMMARY

The invention relates to contact smartcard readers and the conversion thereof to contactless. The invention can generally be broken down into two parts, firstly a dual interface reader (Interface Conversion Reader) in the form of a card body which can be inserted into a conventional contact smartcard reader and convert said reader into a contactless reader, allowing users to upgrade their smartcard infrastructure with RFID technology. Secondly, a dual interface reader (Interface Conversion Reader) with transponder functionality (RF interface, encryption codes, EEPROM and possibly an operating system) to communicate in active and passive mode for physical & logical access as well as for payment, ticketing, couponing and secure access applications.

Building on the concept of an RFID reader and contactless smartcard being used in combination as paired devices for applications such as physical and logical access as described in Cases 16 & 18, it is proposed in the current invention to marry the reader and smartcard function into one apparatus having the format of a card body.

According to an embodiment of the invention, the apparatus has two interfaces namely a smartcard contact interface interrogating according to ISO 7816 and a contactless reader interface operating according to ISO 14443, thus creating a dual interface reader (Interface Conversion Reader). The current invention differs from the U.S. Pat. No. 6,398,116 which describes a dual interface card (Interface Conversion Reader) transferring data and/or energy with a write/read device (terminal) without contacts and optionally with contacts, in so far that the invention relates not to the card but to the reader (terminal).

According to an embodiment of the invention the dual interface reader (Interface Conversion Reader) avails of a Near Field Communication (NFC) controller having an ISO 7816 interface to communicate via contact terminals with a conventional smartcard reader or terminal and an RFID interface such as ISO 14443 or ISO 15693 to communicate with a contactless smartcard, fob or token. Optionally, the NFC controller could be provided with a USB interface.

According to an embodiment of the invention the dual interface reader (Interface Conversion Reader) can act as a reader in active mode (when inserted into a contact reader) or in passive mode as a transponder (relying on the energy provided by an external RFID reader).

According to an embodiment of the invention, a method is proposed to use the dual interface reader (Interface Conversion Reader) to convert a legacy contact smartcard reader into a contactless reader.

In another embodiment of the invention, a method is proposed to use the dual interface reader (Interface Conversion Reader) as a passive transponder for physical access, and when inserted into a contact reader connected to a computer network to be used for logical access.

In an embodiment, the invention generally comprises plugging a unit (referred to as an Interface Conversion Reader, or “ICR”) into a contact reader (contact-based terminal), and the unit can communicate with a contactless card.

The Interface Conversion Reader (ICR) is generally in the form of a card which can plug into a contact-based terminal, and which converts ISO 7816 (contact) data format to contactless (e.g. ISO 14443, NFC, etc.) and a contactless smartcard interface which manages the ISO 14443 data and communicates with the proximity integrated circuit card (PICC, which is a contactless card).

The implementation of a hardware & software solution which enables a transparent exchange of data between a contact smartcard reader (connected to a host) and a proximity integrated circuit card (PICC, which is a contactless card). The application resides at the host and transfers data via the contact smartcard reader to the interface conversion reader which in turn communicates with the proximity integrated circuit card. Since the data transmission is fully transparent there is no need to change the application. The interface conversion reader is powered up by inserting it into the slot, provided for a contact smartcard, in the contact smartcard reader. The connections to the interface conversion reader include power (+ & ground), clock, I/O signal (data) and reset.

By mapping ISO 7816 commands of the terminal into proprietary commands, it is also possible to access PICCs which are not compatible with ISO 14443-4 (e.g., Mifare).

In order to increase the performance of the interface conversion reader (e.g. speed up communication) it may be necessary to use a clock with higher frequency running asynchronous to the clock which is supplied by the terminal. This can be achieved by using a separate oscillator or a frequency multiplier. (Phase Locked Loop, PLL)

The contactless smartcard interface may run with an independent clock source. The applied clock frequency (e.g. 13.56 MHz/27.12 MHz) has to fulfill the requirements of the RFID technology.

### BRIEF DESCRIPTION OF THE DRAWINGS

Reference will be made in detail to embodiments of the disclosure, examples of which may be illustrated in the accompanying drawing figures (FIGs). The figures are intended to be illustrative, not limiting. Although the invention is generally described in the context of these embodiments, it should be understood that it is not intended to limit the invention to these particular embodiments.

FIGS. 1A and 1B are diagrams illustrating an embodiment of the invention

FIG. 2 is a diagram illustrating prior art smartcard.

FIG. 3 is a diagram of additional options for the invention.

FIG. 4 is a plan view of a card body having a contract interface and an antenna, according to the invention.

FIG. 5 is a plan view of the card body of FIG. 4 inserted into a conventional contact reader.

### DETAILED DESCRIPTION

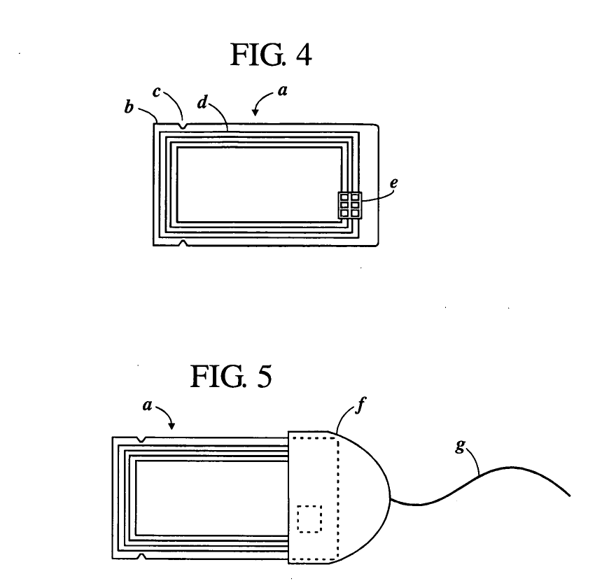

FIG. 4 illustrates a card body having a contact interface and an antenna routed along the perimeter of the card, as well as two notches to facilitate the insertion or withdrawal of the card from a contact reader or terminal.

FIG. 5 illustrates a card body inserted into a conventional contact reader (desktop) with a portion of the card body protruding out of the reader to allow for RFID communication with a contactless card, fob or token. Not shown is the possibility of connecting a USB cable directly to the card body.

### FIGS. 4 and 5 Show the Following Elements and Features:

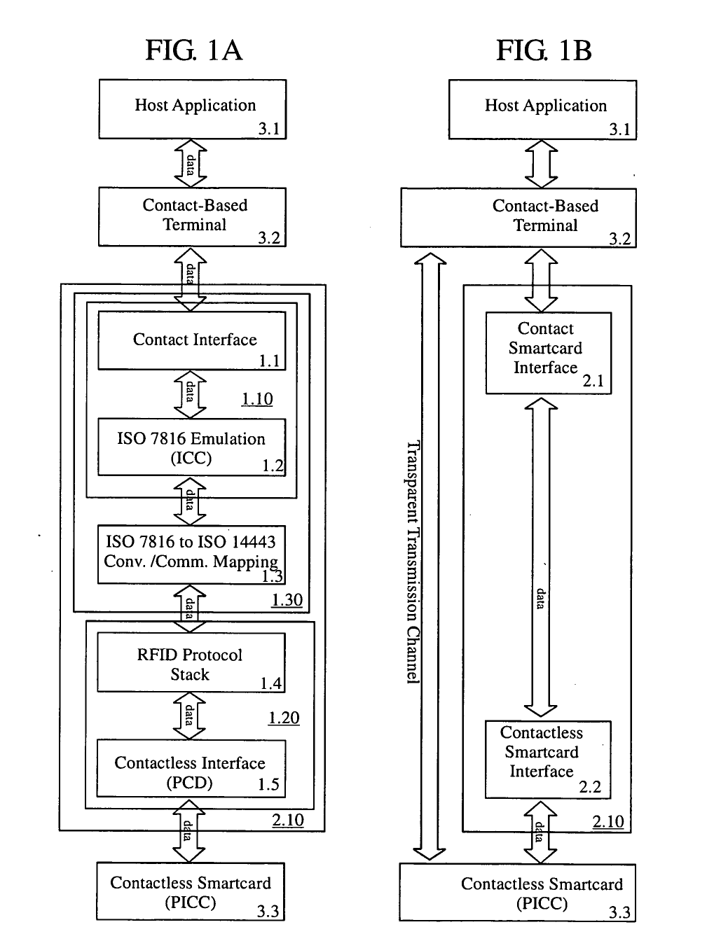

a: Dual Interface Reader (Interface Conversion Reader) in ISO card format
b: Card body
c: Notches or groves to facilitate the insertion or withdrawal of the card into or from a reader
d: The antenna, which is connected to the chip (module) “e”. Normally you would not see the antenna wire because it is laminated.
e: The chip module which may be similar or exactly the same as the chip module on a telephone card, but with one difference, on the face down side of the chip module is the connection to the antenna. So in simple terms, the contacts on the face up side (visible in FIG. 1) of the chip module connect with the contacts in the reader (when inserted), and the terminal areas (two) on the face down side (not visible in FIG. 1) connect to the antenna “d”.
f: Conventional contact reader
g: Cable to a computer such as a USB cable or PS2

The dimensions of the card body b can be in accordance with ISO 7810, but for some applications it may be advantageous to have a longer card body to optimize the performance of data transmission by electromagnetic waves to and from an external transponder or contactless card.

The card body can include a display, LEDs, extended memory and switching elements to enhance user friendly operation.

A booster antenna not connected to the first antenna may be used to improve the read/write distance. The booster antenna may be integrated into a sleeve that slips over the protruding (from the contact reader) end of the card.

### TECHNICAL DETAILS

Since both, contact cards and contactless smartcards commonly behave as defined in ISO 7816-3 (and higher) and ISO 14443-4, the application data (e.g. Read binary command) are the same in both worlds. The main goal is to achieve a conversion between both standards.

### DESCRIPTION/IMPLEMENTATION

FIG. 1 (A&B) is a diagram of functional description. 1A has more detail than 1B.

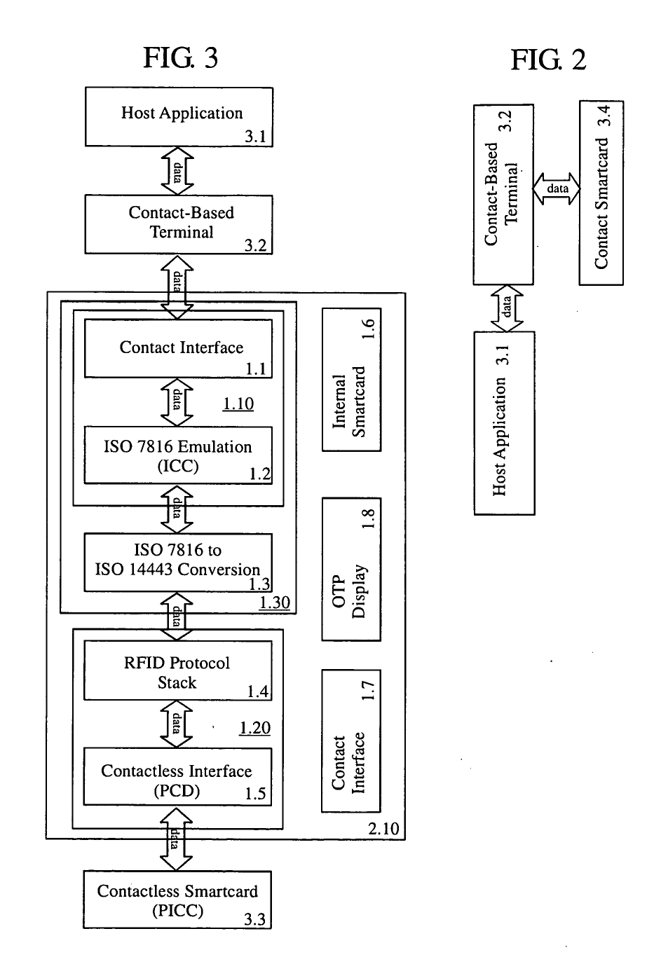

FIG. 2 is a diagram of previous function with contact smartcard. (Prior Art)

FIG. 3 is a diagram of additional options

Generally, throughout the descriptions (and figures),
(1.x) Refers to low level implementation details
(2.x) Refers to system level implementation details
(3.x) Refers to details beyond the system border (outside world)

Blocks may represent hardware, software or data flow.

More particularly, in FIG. 1A (left, upper),
(1.10) Contact-Smartcard Interface comprising:
   (1.1) Contact Interface: hardware, Provides connection with a standard contact based terminal (3.2) and makes specified contacts (CLK, IO, RST, VCC, GND) available. The contact interface (1.1) provides power supply for circuit (2.10). No external power supply is necessary.
   (1.2) ISO 7816 Emulation ICC: hardware and software, Provides emulation of an ICC. Can be done either by software or hardware. (1.2) Detection of the CLK signal of the terminal and generation of internal CLK′ which is either synchronous or asynchronous to CLK. Conversion unit (1.30) runs with CLK′. (1.2) Reset handling, generation of I/O signals (asynchronous UART), calculation of I/O baud rate
      (1.30) Conversion Unit comprising:
      (1.10) Contact smartcard interface, described hereinabove; and
(1.3) ISO 7816 to ISO 14443 conversion and command mapping: software, Provides reception of ISO 7816 compatible data, behaves like a smartcard (ICC). (1.3) Conversion of ISO 7816 frame into ISO 14443 compatible frame (for PICC)-Mapping of ISO 7816 commands
(1.20) Contactless Smartcard Interface comprising:
   (1.4) RFID Protocol Stack: software, Exchange ISO 14443 frame via contactless interface; and
   (1.5) Contactless Interface (PCD): hardware, PCD handles RFID communication
(2.10) Interface Conversion Reader comprising:
   (1.20) contactless smartcard interface, described hereinabove; and
   (1.30) conversion unit as described hereinabove
(3.1) Host application: hardware and software, may be a PC (personal computer)
(3.2) Contact based terminal: hardware,
(3.3) Contactless smartcard (PICC): hardware,
   PICC can be any contactless smartcard (e.g. ISO 14443, NFC)

More generally, in FIG. 1B (right, lower),
(2.10) Interface Conversion Reader: comprising:
   (2.1) Contact smartcard interface: dataflow,
   (2.2) Contactless smartcard interface: dataflow,

A transparent transmission channel is established between:
(3.2) contact based terminal, described hereinabove; and
(3.3) contactless smartcard (PICC), described hereinabove.

The new card, the ICR 2.10, could have a slot in it which would allow the insertion and read of a contact smartcard.

The new card, the ICR 2.10, could have memory in it, and it would act itself like a smartcard. (1.2, 1.3) Proprietary know how could be included. (2.1, 2.2, 2.10) Could be included (e.g. as data exchange concept)

FIG. 2 illustrates prior art. (3.1) Smartcard applications, hardware and software; transmit data via (3.2) a contact-based terminal; to (3.4) the contact smartcard.

In the new system (FIG. 1) the same smartcard application (3.1 mostly hosted on a PC) transmits data via the terminal to the Interface Conversion Interface Reader (2.10). The Interface Conversion Reader (2.10) itself acts as contact smartcard (similar to 3.5) and roots the data (mostly APDUs designated for the contact smartcard) to the contactless interface (1.5) and finally to the contactless smartcard (3.3)

Since the interface conversion reader (“ICR” 2.10) is not visible for the higher protocol layers (mainly the application), the link between the contact based terminal (3.2) and the contactless smartcard (3.3) behaves like a transparent transmission channel. (FIG. 1B)

When upgrading to a contactless system it is not necessary to change host application (3.1)

The solid line around (2.10) represents the system border. The interface on the top (left) side consists of the typical contact interface (CLK, IO, RST, VCC, GND). The bottom (right) side offers a contactless interface like a PCD.

### ADDITIONAL FEATURES

The device could be used as a contact based smartcard.
   Since the device always needs an additional microcontroller it is possible to store data inside of it. The complete device behaves like a contact smartcard.
   Needs (minimal) implementation of a smartcard OS

FIG. 3 shows that the ICR 2.10 could also comprise:
(1.6) an internal smartcard function; hardware (which would have memory, which could be a SIM card) and
(1.7) a slot with a contact interface for a contact card, hardware. The additional interface for a contact smartcard (FIG. 3, 1.7) would make it possible to connect contactless smartcards as well as contact smartcards.
(1.8) An OTP generator & display—the integration of a “One Time Password” (OTP) generator operating in time synchronous with the host or with an Internet atomic clock, having a display and keypad

While the invention has been described with respect to a limited number of embodiments, these should not be construed as limitations on the scope of the invention, but rather as examples of some of the embodiments. Those skilled in the art may envision other possible variations, modifications, and implementations that are also within the scope of the invention, based on the disclosure(s) set forth herein.

What is claimed is:

1. A method of communicating with a contactless card comprising:
providing a contact-based terminal; and
plugging an interface conversion reader into the contact-based terminal.

2. An interface conversion reader (ICR) to convert a contact smartcard reader to contactless comprising:
a rectangular card body format for insertion into a slot provided in a conventional contact smartcard reader, with a portion of said card body protruding out of the reader after insertion;
wherein the protruding portion of said card body incorporates a contactless interface with an antenna to inductively couple and communicate with a contactless smartcard in close proximity.

3. The interface conversion reader (ICR) of claim 2, wherein:
the ICR operates as an active device when inserted into a contact smartcard reader to convert said contact smartcard reader into a contactless reader, and as a passive device with transponder functionality when removed from said contact smartcard reader to operate as identification device.

4. The interface conversion reader (ICR) of claim 2, further comprising:
an ISO 7816 contact interface to communicate with the contact smartcard reader and to draw power from said reader to activate the conversion of ISO 7816 data to ISO 14443 data and an antenna connected to the conversion circuit via a contactless smartcard interface to inductively couple with a proximity integrated circuit card

5. The interface conversion reader (ICR) of claim 2, further comprising:
a “One Time Password” (OTP) generator operating synchronous with the host computer connected to the contact smartcard reader or with an internet atomic clock, having a display and keypad.

6. An interface conversion reader (ICR) further comprising:
a universal serial bus (USB) interface.
